(19) United States
(12) Patent Application Publication
(10) Pub. No.: US 2017/0339190 A1
(43) Pub. Date: Nov. 23, 2017

(54) DEVICE-SPECIFIC PACKET INSPECTION PLAN

(71) Applicant: Cisco Technology, Inc., San Jose, CA (US)

(72) Inventors: Steve EPSTEIN, Hashmonaim (IL); Hillel SOLOW, Beit Shemesh (IL); Ezra DARSHAN, Beit Shemesh (IL)

(21) Appl. No.: 15/161,313

(22) Filed: May 23, 2016

(51) Int. Cl. H04L 29/06

(52) U.S. Cl. CPC H04L 63/20; H04L 63/1416; H04L 63/1433

(57) ABSTRACT

In one embodiment, a system includes a hardware processor and a memory to store data used by the hardware processor, wherein the hardware processor is operative to calculate, for each one device of a plurality of devices, a device-specific packet inspection plan based on (a) a security vulnerability score for the one device; and (b) a damage score for the one device, wherein for each one device of the plurality of devices, the device-specific packet inspection plan includes at least one of the following (a) a percentage of a plurality of packets, destined for the one device, to be inspected for compliance with at least one intrusion detection/protection system rule and (b) instructions on which intrusion detection/protection system rules to use to inspect a multiplicity of the plurality of packets destined for the one device. Related apparatus and methods are also described.

### TECHNICAL FIELD

The present disclosure generally relates to Intrusion Protection Systems (IPS) or Intrusion Detection Systems (IDS).

### BACKGROUND

Intrusion Protection Systems (IPS) or Intrusion Detection Systems (IDS) may be operative in devices with constrained resources (e.g., central processing unit (CPU), memory etc.). Therefore, the number of IPS/IDS rules that can be enforced or packets that can be inspected may be limited.

### BRIEF DESCRIPTION OF THE DRAWINGS

The present disclosure will be understood and appreciated more fully from the following detailed description, taken in conjunction with the drawings in which:

FIG. 1 is a block diagram view of home network devices being controlled remotely constructed and operative in accordance with an embodiment of the present disclosure;

FIG. 2 is a block diagram view of a security system constructed and operative in accordance with an embodiment of the present disclosure;

FIG. 3 is a flow chart of exemplary steps in a method of operation of a vulnerability/damage analysis system in the security system of FIG. 2; and

FIG. 4 is a flow chart of exemplary steps in a method of operation of a network distribution device in the security system of FIG. 2.

### DESCRIPTION OF EXAMPLE EMBODIMENTS

### Overview

There is provided in accordance with an embodiment of the present disclosure, a system including a first hardware processor, and a memory to store data used by the first hardware processor. The first hardware processor is operative to calculate, for each one device of a plurality of devices, a device-specific packet inspection plan based on (a) a security vulnerability score for the one device, and (b) a damage score for the one device. For each one device of the plurality of devices, the device-specific packet inspection plan includes at least one of the following (a) a percentage of a plurality of packets, destined for the one device, to be inspected for compliance with at least one intrusion detection/protection system rule, and (b) instructions on which intrusion detection/protection system rules to use to inspect a multiplicity of the plurality of packets destined for the one device. The first hardware processor is operative to calculate the security vulnerability score for the one device based on at least one of the following a security level associated with the one device, and a security level of communication between the one device and at least one other device. The damage score for the one device is based on damage caused by a security breach in the one device.

There is also provided in accordance with another embodiment of the present disclosure, a network distribution system including a network input/output sub-system to receive, for each one device of a plurality of devices, a plurality of packets destined for the one device and a hardware processor. The hardware processor is operative to run an intrusion detection/protection sub-system to selectively inspect, for each one device of the plurality of devices, the plurality of packets destined for the one device a device-specific packet inspection plan of the one device. The device-specific packet inspection plan is based on (a) a security vulnerability score for the one device, and (b) a damage score for the one device. For each one device of the plurality of devices, the device-specific packet inspection plan includes at least one of the following (a) a percentage of a plurality of packets, destined for the one device, to be inspected for compliance with at least one intrusion detection/protection system rule, and (b) instructions on which intrusion detection/protection system rules to use to inspect a multiplicity of the plurality of packets destined for the one device. The security vulnerability score for the one device is based on at least one of the following a security level associated with the one device, and a security level of communication between the one device and at least one other device. The damage score for the one device is based on damage caused by a security breach in the one device.

### Detailed Description

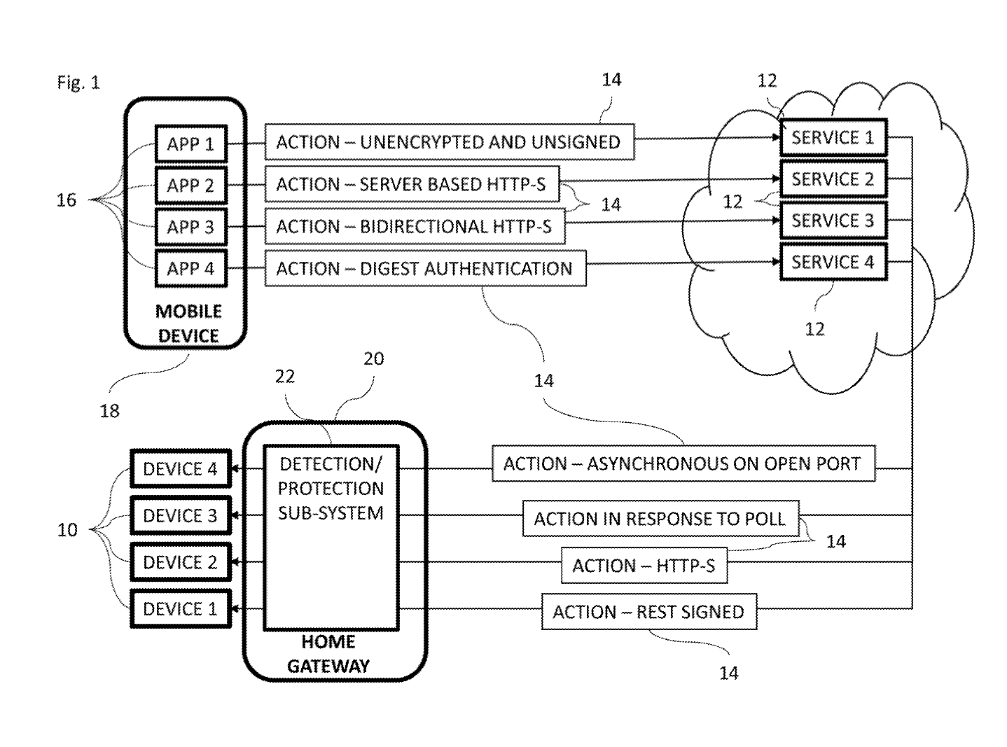

Reference is now made to FIG. 1, which is a block diagram view of home network devices 10 being controlled remotely constructed and operative in accordance with an embodiment of the present disclosure. The home network devices 10 may include home appliances for example, but not limited to, refrigerators, freezers, sensors, cameras, heating systems, cooling systems, ovens, stoves, dishwashers, washing machines, personal computers, lighting systems and home entertainment systems etc. The home network devices 10 may receive software, software updates and other data from a manufacturer associated with each of the home network devices 10 via a service 12 of the manufacturer. The services 12 may also be used to monitor and control the home network devices 10 within a home automation setting. Each service 12 is generally associated with a different manufacturer. The home network devices 10 may also receive actions 14 and other data from a user of the home network devices 10, for example, in order to affect actions 14 on the home network devices 10. The user may select the actions 14 using an application 16 running on a mobile device 18 of the user. The applications 16 may be per manufacturer or per home network device 10. Each action 14 may be routed from the mobile device 18 via the manufacturer specific service 12 of the manufacturer and via a home gateway 20 to the relevant home network devices 10. The home gateway 20 includes an intrusion detection/protection sub-system 22 to inspect packets destined for the home network devices 10 according to Intrusion Protection System (IPS) or Intrusion Detection System (IDS) rules. In many home gateways, the IPS/IDS may be implemented in operating system (OS) user space and not kernel space, generally making deep packet inspection costly. The home gateway 20 may be termed “a constrained device” in that the home gateway 20 is unable to scan all incoming packets using all IPS/IDS rules using only a proportion of its resources. By way of example, a home gateway 20 that supports 300 Mb/s downstream bandwidth may route 100% of packets arriving up to this bandwidth to home network devices 10, including applying some IPS/IDS rules. The detection/protection system 22 may perform Deep Packet Inspection (DPI) on packets only up to 5% of the total downstream bandwidth (i.e. only up to 15 Mb/s) without using more than 10% of the total resources available to home gateway 20 (central processing unit (CPU) and random access memory (RAM)). A Service Provider which provides the detection/protection system 22 may not want to allocate more than 10% of the total resources of home gateway 20 to the task of DPI. In such a sense, the home gateway 20 is said to be “constrained” with respect to performing DPI on the packets.

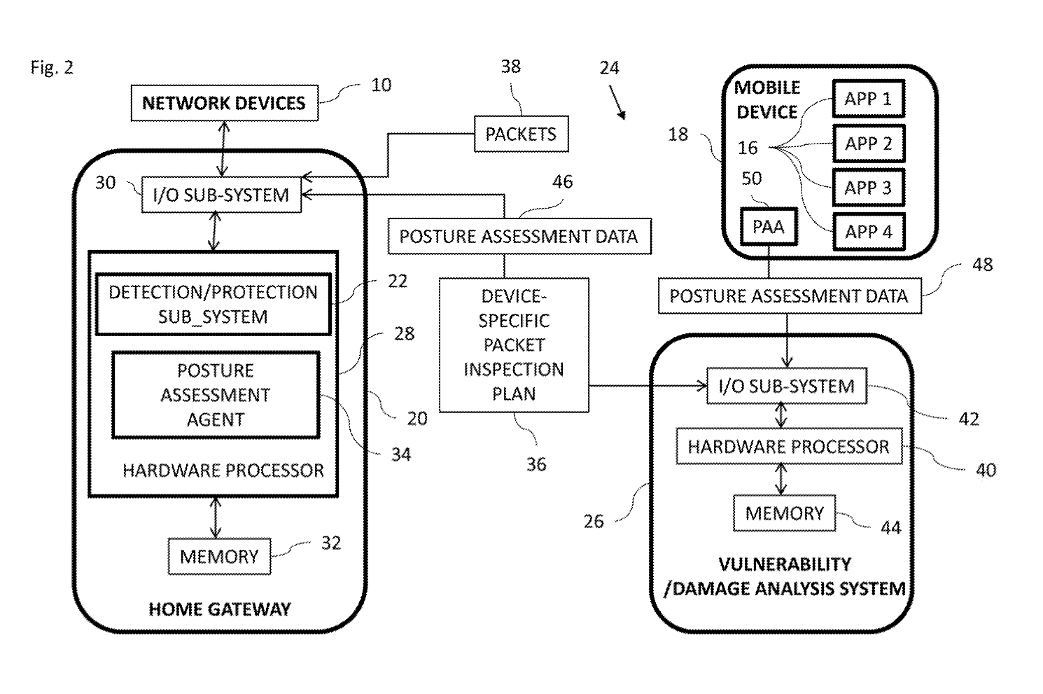

Reference is now made to FIG. 2, which is a block diagram view of a security system 24 constructed and operative in accordance with an embodiment of the present disclosure. The security system 24 includes a vulnerability/damage analysis system 26, a plurality of home gateways 20 (only one shown for the sake of clarity) and a plurality of mobile devices 18 (only one shown for the sake of clarity).

The vulnerability/damage analysis system 26 includes a hardware processor 40, a network input/output sub-system 42 and a memory 44. The vulnerability/damage analysis system 26, including the hardware processor 40, is disposed in a server remote to the home gateway 20 (or remote to a network distribution device which may be used instead of the home gateway 20).

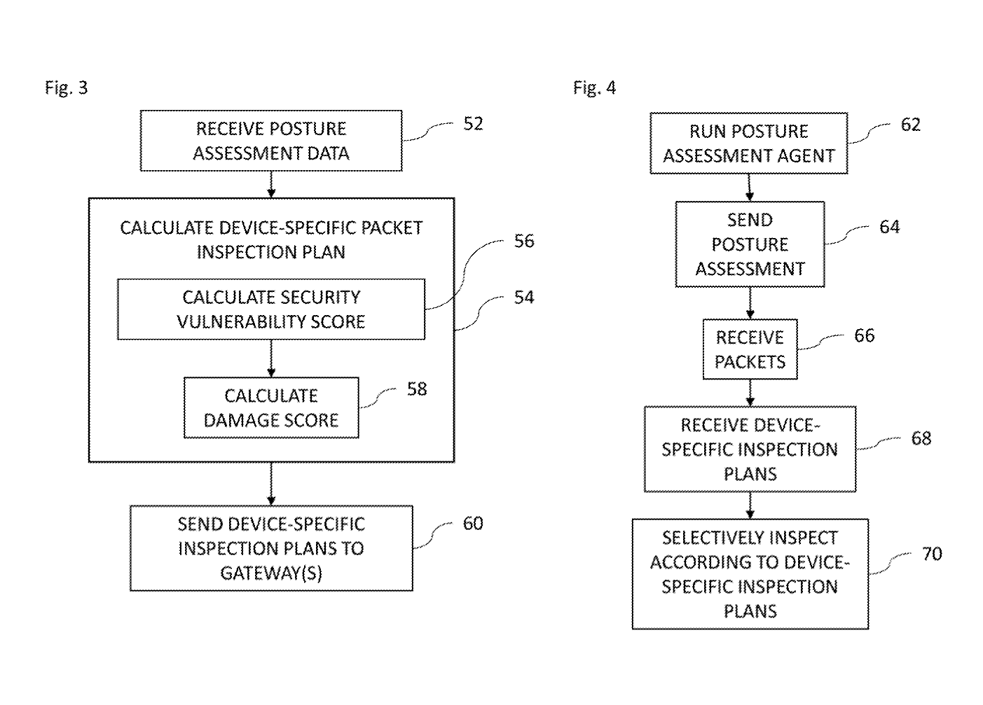

The network input/output sub-system 42 is operative to receive and send data to the home gateway 20 and mobile device 18. The memory 44 is operative to store data used by the hardware processor 40. The hardware processor 40 of the vulnerability/damage analysis system 26 is operative to prepare a device-specific packet inspection plan 36 for each of the home network devices 10 in each of the home networks to be implemented by each home gateway 20. The device-specific packet inspection plan 36 for each home network device 10 is based on: (a) a security vulnerability score for the device 10; and (b) a damage score for the home network device 10. The security vulnerability score is based on posture assessment data 46 received from the relevant home gateway 20 and posture assessment data 48 received from the relevant mobile device 18 via the network input/output sub-system 42. The security vulnerability score is described in more detail with reference to FIGS. 1 and 3. The damage score is described in more detail with reference to FIG. 3. For each home network device 10, the device-specific packet inspection plan 36 includes one or more of the following: a percentage of packets 38, destined for that home network device 10, to be inspected for compliance with one or more IPS/IDS rules by the relevant home gateway 20; and instructions on which IPS/IDS rules to use to inspect the packets 38 (or a percentage thereof) destined for that device 10 by the relevant home gateway 20.

For the sake of simplicity, the description below refers to a single home gateway 20 and a single mobile device 18.

The home gateway 20 includes a hardware processor 28, a network input/output sub-system 30 and a memory 32. The hardware processor 28 is operative to run the intrusion detection/protection sub-system 22 and a posture assessment agent 34. The posture assessment agent 34 is operative to perform a posture assessment of the home network devices 10 yielding the posture assessment data 46 for forwarding to the vulnerability/damage analysis system 26. The network input/output sub-system 30 receives the packets 38, (including the packets of the actions 14 (FIG. 1) from the services 12 (FIG. 1) and also other servers. The network input/output sub-system 30 transfers the received packets 38 to the intrusion detection/protection sub-system 22. The intrusion detection/protection sub-system 22 selectively inspects the received packets 38 in accordance with the device-specific packet inspection plan 36 before passing the packets 38 to the home network devices 10.

The mobile device 18 includes a posture assessment agent 50 to perform a posture assessment of the applications 16 running on the mobile device 18 yielding the posture assessment data 48 for forwarding to the vulnerability/damage analysis system 26.

It should be noted that the security system 24 may be implemented to provide the device-specific packet inspection plan 36 to any suitable device besides household appliances, for example, but not limited to, computer equipment, telecommunication equipment, factory equipment etc. Similarly, it will be appreciated that the posture assessment agent 34 and the inspection sub-system 22 may run on any suitable network distribution device, for example, but not limited to, a router, network gateway or Fog node.

Reference is again made to FIG. 1. As described above, the calculation of how many of the packets 38 (FIG. 2) to inspect and/or which rules to apply is based on the vulnerability of each home network device 10 and its end-to-end system as well as the damage caused by a security breach in that home network device 10. FIG. 1 shows that the different actions 14 have different security levels, e.g., unencrypted and unsigned, server based HTTP-S, bidirectional HTTP-S etc. The end-to-end security enforced by each separate manufacturer may vary dramatically given there is no standard and each manufacturer implements its own solution. The following is a non-limiting list of different security levels being enforced:
(i) some manufacturer applications 16 and services 12 communicate over a secure channel such as Transport Layer Security (TLS), others do not;
(ii) some manufacturer applications 16 and services 12 communicate over bidirectional TLS, others over unidirectional TLS;
(iii) some manufacturer applications 16 and services 12 use pre-shared keys, others use certificates;
(iv) for the manufacturers using certificates, certificate revocation as well as expiration/renewal may be implemented or not;
(v) when the application 16 is authenticated (e.g., using a client certificate etc.), the mobile device 18 protection of identity data may vary dramatically across manufacturer applications;
(vi) when the application 16 authenticates itself based on a username and password and/or secure cookie, the strength of that password as well as refresh time of that password and cookie may vary significantly;
(vii) some applications 16 have open ports which make the applications 16 much more vulnerable to denial of service and other attacks initiated from any server based on port forwarding on the home gateway 20, others do not;
(viii) some manufacturer services 12 meticulously update their home network devices 10 with the latest patches to mitigate security holes, others do not, making the non-updated devices significantly more vulnerable;
(ix) some home network devices 10 may only communicate with their manufacturer service 12, while other home network devices 10 may communicate with multiple servers and hence being prone to potential attacks from multiple places; and
(x) some home network devices 10 may provide their own anti-malware defense by internally running a host-based intrusion detection algorithm, some do not. It will be appreciated that many other security vulnerabilities may be considered.

Each security vulnerability type is given a score, for example, the higher perceived security vulnerability, the higher the score allocated. A security vulnerability score is calculated for each home network device 10 based on summing the scores of the various security vulnerabilities possibly applying a different weight to different security vulnerabilities, for example, but not limited to, one or more of the security vulnerabilities listed above.

Reference is again made to FIG. 2. As described above, the security vulnerabilities are derived from the posture assessment data 46, 48 by the vulnerability/damage analysis system 26. Therefore, the posture assessment agent 34 of the home gateway 20 and the posture assessment agent 50 of the mobile device 18 collect data relating to the security vulnerabilities used to calculate security vulnerability score and the collected data is included in the posture assessment data 46, 48. The posture assessment agent 34 and the posture assessment agent 50 (possibly tied to each individual manufacturer application 16) may be operative to report the vulnerability of each home network device 10 and its end-to-end system, such as, does the home network device 10: leave open ports, receive on-going patches, have correct secure communication and how secure, run its own anti-malware defense such as host-based intrusion detection codes (HIDS) and communicate with multiple servers in the cloud.

The damage score for each home network device 10 is based on damage caused by a security breach in that device 10. The damage score for each home network devices 10 may be based on a value (cost) of the device 10 or a repair cost of the device 10 or a cost of items used with the device, e.g., the cost of food in a refrigerator. The damage caused by a security breach in the home network devices 10 varies from one of the home network devices 10 to another. For example, causing a refrigerator to break may cost thousands of dollars. Causing a refrigerator to malfunction may result in the loss of the food inside. Breaking a sensor may only result in the loss of a few dollars. The damage score may be a measure of personal damages, e.g., how much someone would pay not to be subject to a particular security attack. For example, misuse of a camera, while generally not resulting in a direct financial cost, may result in a loss of privacy which may be worth a lot more to someone than breaking a cooling system.

The hardware processor 40 of the vulnerability/damage analysis system 26 is operative to calculate a combined vulnerability-damage score by combining, e.g., summing, the security vulnerability score and the damage score. Different weightings may be applied by the hardware processor 40 to security vulnerability score and the damage score when combing them together. The hardware processor 40 typically divides resources of the intrusion detection/protection sub-system 22 for inspecting packets 38 among the different home network devices 10 so that more resources are allocated to inspecting packets 38 destined to the home network devices 10 with a higher combined vulnerability-damage score, and vice-versa. One option for dividing the resources of the intrusion detection/protection sub-system 22 is for the hardware processor 40 to calculate, per home network device 10, a percentage of the packets 38 destined for the home network device 10 that should be inspected for compliance with one or more IPS/IDS rules by the home gateway 20. The percentage of packets 38 to be inspected for one of the home network devices 10 is included in the device-specific packet inspection plan 36 for that home network device 10.

Another option for dividing the resources of the intrusion detection/protection sub-system 22 is for the hardware processor 40 to calculate, per home network device 10, which IPS/IDS rules to use to inspect the packets 38 (or a percentage thereof) destined for the device 10 by the home gateway 20. Rules may be allocated by the hardware processor 40 calculating how the resources of the intrusion detection/protection sub-system 22 are divided among the home network devices 10 according to the combined vulnerability-damage score of each home network device 10. The vulnerability/damage analysis system 26 may include a prioritized list of IPS/IDS rules and an associated estimated resource usage of each rule in the prioritized list maintained by the hardware processor 40. The hardware processor 40 then allocates each home network device 10 rules from the prioritized list starting with the highest priority rule and working down the list until the resource usage allocated to that home network device 10 is used up by the selected rules. It should be noted that the prioritized list may be common to all the home network devices 10 or each home network device 10 may have its own prioritized list of rules tailored to the particular known security risks for the type of home network device 10. The rules selected for one of the home network devices 10 are included in the device-specific packet inspection plan 36 for that home network device 10. The above calculations may be performed assuming that all or only a fraction of the packets are inspected for each selected rule.

Reference is now made to FIG. 3, which is a flow chart of exemplary steps in a method of operation of the vulnerability/damage analysis system 26 in the security system 24 of FIG. 2. Reference is also made to FIG. 2. The network input/output sub-system 42 is operative to receive: the posture assessment data 46 from a network distribution device (e.g., the home gateway 20) of a network including devices (e.g., the devices 10); and the posture assessment data 48 from the mobile device 18 running the software applications 16 to control the devices 10 (block 52).

The hardware processor 40 is operative to calculate, for each device 10, a device-specific packet inspection plan 36 based on: (a) a security vulnerability score for that device 10; and (b) a damage score for that device 10. For each device 10, the device-specific packet inspection plan 36 includes at least one of the following: a percentage of the packets 38, destined for that device 10, to be inspected for compliance with at least one intrusion detection/protection system rule; and instructions on which intrusion detection/protection system rules to use to inspect the packets 38 (or a percentage of the packets 38) destined for that home network devices 10 (block 54).

Some sub-steps of the step of block 54 are now described. The hardware processor 40 is operative to calculate the security vulnerability score for each device 10 based on at least one of the following: a security level associated with that device 10; and a security level of communication between the device 10 and at least one other device (e.g. the server of one of the services 12 (FIG. 1) and the mobile device 18). The hardware processor 40 is operative to calculate the security vulnerability score for each device 10 based on different factors including, but not limited to, at least one of the following: whether communication is over a secure channel; whether communicate is bidirectional or unidirectional; whether pre-shared keys or certificates are used; whether certificate is implemented; whether certificate expiration and/or renewal is implemented; how identity data is protected; how strong are passwords being used; password refresh time; cookie refresh time; do application have open ports; patch update policy; how many servers does the one device communicate with; and provision of anti-malware defense in the one device.

In particular, the hardware processor 40 is operative to calculate the security vulnerability score, for each device 10, at least based on the posture assessment data 46 and the posture assessment data 48 of that device 10 received from the network distribution device and the mobile device 18, respectively (block 56). The hardware processor 40 is operative to calculate the damage score (block 58).

As described above the hardware processor 40 is operative to calculate the combined vulnerability-damage score and how many packets to inspect and/or which rules to use for inclusion in the device-specific packet inspection plan 36 for each device 10. For each device 10, the device-specific packet inspection plan 36 may include a percentage of the packets 38, destined for that device 10, to be inspected for compliance with at least one intrusion detection/protection system rule.

Alternatively, or additionally, for each device 10, the device-specific packet inspection plan 36 may include instructions on which intrusion detection/protection system rules to use to inspect the packets 38 (or a percentage of the packets 38) destined for that device 10. The device-specific packet inspection plan 36 may include intrusion detection/protection system rules selected from a prioritized list of intrusion detection/protection system rules. The prioritized list of intrusion detection/protection system rules may be customized for each device 10 according to at least one security vulnerability of that device 10. The network input/output sub-system 42 is operative to send the device-specific packet inspection plan 36 for each device 10 to the network distribution device (e.g., the home gateway 20) (block 60).

Reference is now made to FIG. 4, which is a flow chart of exemplary steps in a method of operation of a network distribution device in the security system 24 of FIG. 2. Reference is also made to FIG. 2. The network distribution device is now described by way of the home gateway 20. However, it will be appreciated that any suitable network distribution device may be used instead of the home gateway 20.

The hardware processor 28 is operative to run the posture assessment agent 34 to perform a posture assessment yielding the posture assessment data 46 for each device 10 (block 62). The network input/output sub-system 30 is operative to send the posture assessment data 46 for each device 10 to a remote server (e.g., a server of the vulnerability/damage analysis system 26) to calculate the security vulnerability score, for each device 10, at least based on the posture assessment data 46 of the device 10 (block 64). The network input/output sub-system 30 is operative to receive, for each device 10: the packets 38 destined for that device 10 (block 66) from wherever the packets 38 originate; and the device-specific packet inspection plan 36 from the remote server (e.g., a server of the vulnerability/damage analysis system 26) (block 68). The hardware processor 28 is operative to run the intrusion detection/protection sub-system 22 to selectively inspect, for each device 10, the packets 38 destined for that device 10 according to the device-specific packet inspection plan 36 of that device 10 (block 70). In an alternative embodiment, the vulnerability/damage analysis system 26 may be implemented in the home gateway 20.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively or additionally, the software may be stored in tangible, non-transitory computer-readable storage media, such as optical, magnetic, or electronic memory.

It is appreciated that software components may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present disclosure.

It will be appreciated that various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

It will be appreciated by persons skilled in the art that the present disclosure is not limited by what has been particularly shown and described hereinabove. Rather the scope of the disclosure is defined by the appended claims and equivalents thereof.

What is claimed is:

1. A system comprising: a first hardware processor; and a memory to store data used by the first hardware processor, wherein the first hardware processor is operative to calculate, for each one device of a plurality of devices, a device-specific packet inspection plan based on: (a) a security vulnerability score for the one device; and (b) a damage score for the one device, wherein:
for each one device of the plurality of devices, the device-specific packet inspection plan includes at least one of the following: (a) a percentage of a plurality of packets, destined for the one device, to be inspected for compliance with at least one intrusion detection/protection system rule; and (b) instructions on which intrusion detection/protection system rules to use to inspect a multiplicity of the plurality of packets destined for the one device;
the first hardware processor is operative to calculate the security vulnerability score for the one device based on at least one of the following: a security level associated with the one device; and a security level of communication between the one device and at least one other device; and
the damage score for the one device is based on damage caused by a security breach in the one device.

2. The system according to claim 1, further comprising a first network input/output sub-system to receive posture assessment data from a network distribution device of a network including the plurality of devices, wherein the first hardware processor is operative to calculate the security vulnerability score, for each one device of the plurality of devices, at least based on the posture assessment data of the one device received from the network distribution device.

3. The system according to claim 1, further comprising a first network input/output sub-system to receive posture assessment data from a mobile device running a plurality of software applications to control the plurality of devices, wherein the first hardware processor is operative to calculate the security vulnerability score, for each one device of the plurality of devices, at least based on the posture assessment data of the one device received from the mobile device.

4. The system according to claim 1, further comprising a network distribution device including: a second network input/output sub-system to receive, for each one device of the plurality of devices, the plurality of packets destined for the one device; and a second hardware processor to run an intrusion detection/protection sub-system to selectively inspect the plurality of packets destined for the one device according to the device-specific packet inspection plan of the one device.

5. The system according to claim 4, wherein the first hardware processor is disposed in a server remote to the network distribution device, the second network input/output sub-system being operative to receive the device-specific packet inspection plan for each of the plurality of devices from the server.

6. The system according to claim 4, wherein the first hardware processor is disposed in the network distribution device.

7. The system according to claim 1, wherein the damage score for the one device is based on a value of the one device.

8. The system according to claim 1, wherein for each one device of the plurality of devices, the device-specific packet inspection plan includes a percentage of a plurality of packets, destined for the one device, to be inspected for compliance with at least one intrusion detection/protection system rule.

9. The system according to claim 1, wherein for each one device of the plurality of devices, the device-specific packet inspection plan includes instructions on which intrusion detection/protection system rules to use to inspect the plurality of packets destined for the one device.

10. The system according to claim 1, wherein for each one device of the plurality of devices, the device-specific packet inspection plan includes instructions on which intrusion detection/protection system rules to use to inspect the percentage of the plurality of packets destined for the one device.

11. The system according to claim 1, wherein for each one device of the plurality of devices, the device-specific packet inspection plan includes intrusion detection/protection system rules selected from a prioritized list of intrusion detection/protection system rules.

12. The system according to claim 11, wherein the prioritized list of intrusion detection/protection system rules is customized for each one device of the plurality of devices according to at least one security vulnerability of the one device.

13. The system according to claim 1, the first hardware processor is operative to calculate the security vulnerability score for the one device based on at least one of the following: whether communication is over a secure channel; whether communicate is bidirectional or unidirectional; whether pre-shared keys or certificates are used; whether certificate is implemented; whether certificate expiration and/or renewal is implemented; how identity data is protected; how strong are passwords being used; password refresh time; cookie refresh time; do application have open ports; patch update policy; how many servers does the one device communicate with; provision of anti-malware defense in the one device.

14. A network distribution system comprising: a network input/output sub-system to receive, for each one device of a plurality of devices, a plurality of packets destined for the one device; and a hardware processor to run an intrusion detection/protection sub-system to selectively inspect, for each one device of the plurality of devices, the plurality of packets destined for the one device according to a device-specific packet inspection plan of the one device, the device-specific packet inspection plan being based on: (a) a security vulnerability score for the one device; and (b) a damage score for the one device, wherein:
for each one device of the plurality of devices, the device-specific packet inspection plan includes at least one of the following: (a) a percentage of a plurality of packets, destined for the one device, to be inspected for compliance with at least one intrusion detection/protection system rule; and (b) instructions on which intrusion detection/protection system rules to use to inspect a multiplicity of the plurality of packets destined for the one device;
the security vulnerability score for the one device is based on at least one of the following: a security level associated with the one device; and a security level of communication between the one device and at least one other device; and
the damage score for the one device is based on damage caused by a security breach in the one device.

15. The network distribution system of claim 14, wherein the hardware processor is operative to run a posture assessment agent to perform a posture assessment yielding posture assessment data for each one device of the plurality of devices, the network input/output sub-system being operative to send the posture assessment data for each one of the devices to a remote server to calculate the security vulnerability score, for each one device of the plurality of devices, at least based on the posture assessment data of the one device received from the network distribution system.

16. A method comprising:
calculating, for each one device of a plurality of devices, a device-specific packet inspection plan based on: (a) a security vulnerability score for the one device; and (b) a damage score for the one device, wherein for each one device of the plurality of devices, the device-specific packet inspection plan includes at least one of the following: (a) a percentage of a plurality of packets, destined for the one device, to be inspected for compliance with at least one intrusion detection/protection system rule; and (b) instructions on which intrusion detection/protection system rules to use to inspect a multiplicity of the plurality of packets destined for the one device; and
calculating the security vulnerability score for the one device based on at least one of the following: a security level associated with the one device; a security level of communication between the one device and at least one other device, wherein the damage score for the one device is based on damage caused by a security breach in the one device.

17. The method according to claim 16, further comprising receiving posture assessment data from a network distribution device of a network including the plurality of devices, the method further comprising calculating the security vulnerability score, for each one device of the plurality of devices, at least based on the posture assessment data of the one device received from the network distribution device.

18. The method according to claim 16, further comprising: receiving, for each one device of the plurality of devices, the plurality of packets destined for the one device; and selectively inspecting the plurality of packets destined for the one device according to the device-specific packet inspection plan of the one device.

19. The method according to claim 16, wherein for each one device of the plurality of devices, the device-specific packet inspection plan includes a percentage of a plurality of packets, destined for the one device, to be inspected for compliance with at least one intrusion detection/protection system rule.

20. The method according to claim 16, wherein for each one device of the plurality of devices, the device-specific packet inspection plan includes instructions on which intrusion detection/protection system rules to use to inspect the plurality of packets destined for the one device.
